(19) United States
(12) Patent Application Publication
(10) Pub. No.: US 2006/0168012 A1
(43) Pub. Date: Jul. 27, 2006

(54) Method and system for electronic messaging via distributed computing networks

(76) Inventors: Anthony Rose, Sydney (AU); Kevin Bermeister, Sydney (AU)

Correspondence Address: PATENTMETRIX, 14252 CULVER DR. BOX 914, IRVINE, CA, 92604, US

(21) Appl. No.: 10/997,812

(22) Filed: Nov. 24, 2004

(51) Int. Cl. G06F 15/16

(52) U.S. Cl. 709/206

(57) ABSTRACT

The present invention discloses an improved method and system for sending and receiving e-mail messages in a distributed computing network and for enabling users to search for and retrieve content sent as an attachment to e-mail messages on various computing devices participating in a distributed computing network. The present invention also allows for the attachments to be accessed when the original source is not online. The e-mail system of the present invention can also be designed to enable different levels of protection in the transmission and retrieval of attachments, depending on the needs of the user in providing for security in data exchange.

### FIELD OF THE INVENTION

The present invention is related generally to distributed computing networks and, more specifically, to methods and systems for transmitting and receiving electronic mail using distributed computing networks.

### BACKGROUND OF THE INVENTION

Electronic mail or “e-mail” is one of the most popular and widely used methods of communication via a computer network. Each user in the computer network has a unique network address which is typically used by an e-mail server for routing and identifying purposes in delivering a message from one user (the “sender”) to another user (the “recipient”) on the network. Often, one or more additional data files, called “attachments,” are sent along with the e-mail message, which may be opened, accessed, or utilized separately from the e-mail message itself. The attachments, or data files, can comprise data of any format and of any type, such as text, video, images, audio, graphics, and other information. In a typical situation, a sender transmits an e-mail accompanied by an attachment to an e-mail server, which then routes the e-mail and accompanying attachment to a receiver. In such an embodiment, the e-mail server exerts centralized control over e-mail and attachment delivery. As a result, the attachment data cannot be accessed without the recipient connecting to the e-mail server and is subject to the size, data repository, bandwidth, memory, and other restrictions of the e-mail server.

The efficiency of e-mail systems can be degraded significantly by the transfer of messages having large file attachments. This degradation of performance appears to users as a delay in completing the transmission or reception of a message having a large file attachment, since a large amount of network communications bandwidth can be consumed in order to transmit such attachments. Moreover, the user cannot receive other e-mails (those that are queued on the user's e-mail program) while the attachment is being downloaded.

E-mail servers also have storage capacity restraints that are difficult to override. The exchange of attached electronic files via the e-mail system is a storage capacity issue for system administrators because communication of these large file attachments requires e-mail servers having sufficient capacity to store both messages and attachments for system users. E-mail recipients also face issues with limited storage capacity because most e-mail programs provide a low storage mailbox capacity of only 2-4 MB. This forces the user to frequently delete e-mails with large attachments from his or her mailbox in order to have enough free space to continue receiving e-mails. In addition, with limited storage capacity, some e-mail programs limit the size of the attachment that can be sent.

The prior art has made some attempts to enable a user to view just the e-mail message and download any attachments at a later time, thereby avoiding the transmission of attachment content with the e-mail message itself. The prior art fails, however, to disclose methods of transmitting and/or distributing e-mail having attachments associated therewith capable of handling situations where a server is overwhelmed by numerous simultaneous attempts to retrieve the same file. In addition, prior art systems that employ transmission of the network addresses of e-mail attachments in lieu of the content itself fail to provide for retrieval of attachments from an offline source.

What is needed, therefore, is an improved method and system for providing for e-mail attachments to messages that not only offer a more efficient utilization of processor and communications medium bandwidth and memory storage in a computer communications network, but also allow for the attachments to be accessed even if the original server source is not online.

Further, what is needed is a method and system whereby retrieval of attachment data is not dependent on a limited set of original source servers. What is also needed is an e-mail system that is able to sustain adequate levels of speed and performance even when there are a large number of users in the network trying to access the same content from the same source. In addition, what is needed is an e-mail system that can be designed such that it is able to offer different levels of protection in transmission and retrieval of attachments, depending on the needs of the user in providing for security in data exchange. Additionally, what is needed is a system for efficiently transmitting large email attachments.

### SUMMARY OF THE INVENTION

The present invention discloses an improved method and system for sending and receiving e-mail messages in a distributed computing network and for enabling users to search for and retrieve content sent as an attachment to e-mail messages on various computing devices participating in a distributed computing network. The present invention also allows for the attachments to be accessed when the original source is not online; thus, the retrieval of attachment data is not dependent on a limited set of source servers. The e-mail system of the present invention can also be designed to enable different levels of protection in the transmission and retrieval of attachments, depending on the needs of the user in providing for security in data exchange.

In one embodiment, the present invention is directed toward a method for transmitting an e-mail attachment over a network. The method comprises generating a unique identifier for the attachment, the attachment being stored in a storage medium local to at least one computing device coupled to the network, wherein the at least one computing device includes a sender computing device; transmitting the unique identifier along with a primary e-mail message from the sender computing device to a recipient computing device coupled the network; and retrieving the attachment by the recipient computing device. The step of retrieving the attachment further comprises searching for the attachment in at least one computing device coupled to the network using the unique identifier and downloading the attachment from the at least one computing device to a storage means local to the recipient computing device.

The network employed in the present invention is preferably a peer-to-peer network. The unique file identifier may comprise a file hash of the attachment, or it may be any other type of identifier assigned to that attachment. The retrieval of the attachment is performed either upon request by the user of the recipient computing device or automatically for a predetermined set of sending users. Optionally, the sender-computing device may share the attachment with a plurality of computing devices connected to the network.

In another embodiment, the present invention is directed toward a method for retrieving an e-mail attachment by a recipient computing device coupled to a network, the attachment having a unique identifier, the unique identifier being attached to a primary e-mail message received by the recipient computing device. The method comprises searching for the attachment on at least one computing device coupled to the network using the unique identifier and downloading the attachment from at least one computing device to a storage means local to the recipient computing device. If another user on the network were then to receive an email that referenced said attachment, any users who have previously downloaded the attachment may now respond to search requests on the network for said attachment, and may now supply that attachment, or parts of that attachment, to others users who wish to download it.

The present invention is also directed toward computer program codes that employ the processes discussed above. Specifically, in one embodiment, the present invention includes a computer program product for transmitting a file attachment over a network. The computer program product comprises a computer readable program code for generating a unique identifier for the attachment, the attachment being stored in storage means local to at least one computing device coupled to the network, wherein the at least one computing device includes a sender computing device; a computer readable program code for transmitting the unique identifier along with a primary e-mail message from the sender computing device to a recipient computing device coupled the network; and a computer readable program code for retrieving the attachment by the recipient computing device. The computer readable program code for retrieving the attachment further comprises code for searching the attachment in the at least one computing device coupled to the network via the unique identifier and code for downloading the attachment from at least one computing device to a storage means local to the recipient computing device.

In another embodiment, the present invention is directed toward a computer program product for retrieving an e-mail attachment by a recipient computing device coupled to a network, the attachment having a unique identifier, the unique identifier being attached to a primary e-mail message received by the recipient computing device. The computer program product comprises computer readable program code for searching for the attachment on at least one computing device coupled to the network via the unique identifier and computer readable program code for downloading the attachment from the at least one computing device to a storage means local to the recipient computing device.

### BRIEF DESCRIPTION OF THE DRAWINGS

These and other features and advantages of the present invention will be further appreciated, as they become better understood by reference to the detailed description when considered in connection with the accompanying drawings:

FIG. 1 is a block diagram illustrating the main system components of the present invention;

FIG. 2 is a flowchart describing the operational flow of the e-mail system of a preferred embodiment of the present invention;

FIG. 3 is a GUI screen depicting one embodiment of the availability checkbox of the present invention, when the files are selected to be shared;

FIG. 4 is a GUI screen depicting one embodiment of the availability checkbox of the present invention, when the files are not selected to be shared;

FIG. 5 illustrates the main GUI screen and email Inbox according to one embodiment of the present invention;

FIG. 6 depicts one embodiment of the GUI screen for sending an e-mail;

FIG. 7 depicts one embodiment of the GUI screen for viewing a received e-mail;

FIG. 8 illustrates an exemplary display for search and download functions, according to one preferred embodiment of the distributed search system; and

FIG. 9 illustrates one embodiment of enabling a Non-User to send e-mail and attachment(s) to a User of the present invention.

### DETAILED DESCRIPTION OF THE INVENTION

The present invention discloses an improved method and system for sending and receiving e-mail messages in a distributed computing network, enabling users to search for and retrieve content sent as an attachment to e-mail messages, on various computing devices participating in a distributed computing network. Various modifications to the preferred embodiment will be readily apparent to those of ordinary skill in the art, and the disclosure set forth herein may be applicable to other embodiments and applications without departing from the spirit and scope of the present invention and the claims appended hereto. Thus, the present invention is not intended to be limited to the embodiments described, but is to be accorded the broadest scope consistent with the disclosure set forth herein.

As used herein, the term computing devices broadly encompasses any type of computing device that could be placed in data communication with a network. For example, the computing device could be any one of a personal computer, laptop, personal data assistant, mobile phone, wireless e-mail manager, media player, computing tablet, set-top box, networked DVD player, or other type of network access device. Each of said devices has a processor and a communication interface, such as a modem or Ethernet port. Each of said devices also has a local storage means, such as a flash storage device, USB compliant storage device, hard drive, floppy, CD-ROM, zip drive, or DVD device, and/or is capable of being in data communication with a remotely located storage means. Additionally, the term network broadly encompasses any type of network, including local area networks, wide area networks, metropolitan area networks, and wireless networks based on infrared, Bluetooth, wide area data, cellular telephony, WLAN, paging, or satellite technology. The e-mail message attachments of the present invention may be text, video, images, audio, and other information, and is collectively referred to as data hereinafter.

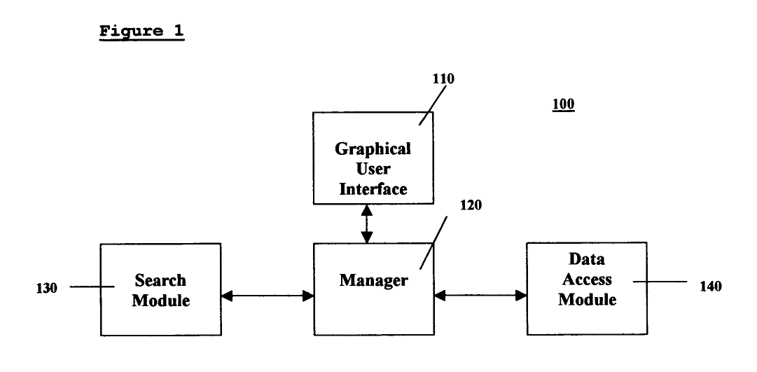

Referring to FIG. 1, a preferred embodiment of the system of the present invention 100 is shown. Application software 100 is designed to be operational on a computing device and receive search requests from a user. One of ordinary skill in the art would appreciate that the program 100 can be installed on any computing device and be compatible with any operating system, including Java-based, Unix-based, open source code based, or Microsoft-based operating systems. One of ordinary skill in the art would also appreciate that the program 100 interfaces with the operating system of a computing device to communicate with processors, peripherals, data transmission elements, data reception elements, displays, and other hardware elements. The program preferably comprises a graphical user interface module 110, a data access module 140, a search module 130, and a manager 120. One of ordinary skill in the art would appreciate that some or all of the aforementioned components can be integrated into another software program, such as an existing peer-to-peer application, operating system, media player, or browser.

In order to enable a user to send and receive e-mails over a distributed computing network, such as a peer-to-peer network (“P2P network”), Graphical User Interface (“GUI”) 110 is provided. The functions of GUI 110 include allowing a user to compose an e-mail message to a recipient, allowing the user to specify a file to attach to the e-mail message, allowing the user to specify preference criteria, and providing a download progress display that helps users keep track of e-mail attachments being downloaded over the distributed computing network. The preference criterion that may be specified include, but is not limited to, options for sending attachments, enhanced security measures, and data availability specifications. GUI 110 also enables a user to store e-mail messages in folders, create an address book, and select e-mail message preference options. In a preferred embodiment, GUI 110 also serves as the user interface for providing instant messaging between users in a distributed computing network.

The manager 120 represents a class of applications used by computing devices to enable users to share files located on their own hard drives as well as to search and download files from other computers over a distributed computing network. The manager also handles functions such as providing secure e-mail transmission with different levels of privacy, and handling e-mail to and from other e-mail systems. Manager 120 coordinates the functions of GUI 110, search module 130 and data access module 140.

When a recipient receives an e-mail with an attached file, the attached file does not consist of the actual file content, but comprises a file download link or identifier that enables the recipient to access the data. This eliminates limitations for the size of attached files. Thus, users can send the download links to files of any size and type, including large multimedia files, as attachments to e-mail messages. Also, since the e-mail message does not consist of the actual attachment content, and the attachment is separate from the e-mail, the user can read the e-mail message prior to deciding whether to download the attachment to their system and can also delete the attachment without deleting the e-mail itself.

The search module 130 facilitates retrieval of attached files. When a recipient indicates that it wants to download an attachment, the manager 120 invokes the search module 130, which searches for the file on the user's hard drive, the hard drive of the sender, the distributed computing network (P2P network) to which the user is connected, and/or on the mail server through which the e-mail was routed. The manager may then display, via GUI 110, a list of all the sources from where the file is available for download, or it may automatically select one or more sources from which to download the attachment, where the download may occur in whole or in part from each source. Preferably, the search module 130 searches the user's hard drive first to check if the attached file is already stored on the user's computing device. The e-mail system may therefore automatically find the attachment again, either when the user opens the particular e-mail with the attachment again or when it receives another e-mail containing the same file. Therefore, the user can save attachments anywhere on his or her computing device. Even if a user deletes a downloaded file from the hard drive, clicking on the attachment link again invokes search module 130 to search for the data, and it can be retrieved from any computing device sharing that file over the distributed peer-to-peer network, as mentioned above.

The data access module 140 enables the actual download of data over the distributed network once the user receives a list of available sources and selects the source for downloading the attachment. In a preferred embodiment, the data access module 140 permits downloading portions of the same file from multiple sources simultaneously, that is, different segments of the same file are downloaded from various sources at the same time. This allows for faster downloads, especially when the file being downloaded is large. The data access module 140 identifies available peer computers in the distributed computing network from which files can be downloaded, manages the establishment of connections between the peer-to-peer (P2P) protocol stacks (not shown) of these computers and handles the download of data. The data access module also provides the option for automatic download of attachments received from persons listed in the user's address book, or from a selected list of user's friends, without requiring the user to specifically click on the attachment link and download it.

In one embodiment, the downloading of portions of a single file from multiple sources is effectuated by having a single link or identifier, associated with the single file, reference a second set of links or identifiers. The second set of links or identifiers are then used to define the location of a plurality of portions the single file. The source locations of the plurality of portions are then accessed and each portion is downloaded into the receiving computing device. Once each portion is downloaded, the file is then capable of being accessed by a user of the receiving computing device. One of ordinary skill in the art would appreciate that the association of a link or identifier with a file location can be achieved by using a central index that is distributed to a plurality of computing devices operating in a network and made accessible to other computing devices on the network. The central index associates identifiers, such as file hashes, file names, source indicators, time stamps, file formats, file authors, available file uses, or any set of data capable of identifying a file, with file locations. Alternatively, rather than be accessed through a single link or identifier, the second set of links or identifiers can be integrated into the email attachment itself. Alternatively, the list of available sources may be dynamically determined by searching the network, so that no pre-determined second set of links is required.

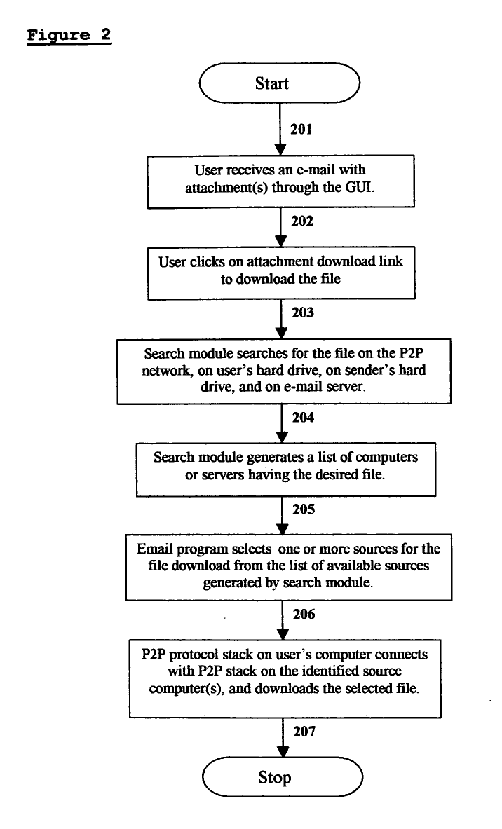

Referring now to FIG. 2, the operational flow of the e-mail system of the present invention 100 is described. A user operates a computing device, which is in data communication with a distributed network. The user accesses public or private networks using the computing device. The user employs the GUI to access the e-mail system of present invention 100, via the computing device. As shown in step 201, a user receives an e-mail with one or more attachments through the GUI 110 of the e-mail system. On reading the e-mail, if the user wishes to download the attachment, it selects the attachment download link contained in the e-mail message, as shown in step 202. Selecting the attachment link invokes the search module 130 of the e-mail system, which searches for the attachment on the user's hard drive, the hard drive of the sender, the distributed computing network (P2P network) to which the user is connected, or on the mail server through which the e-mail was routed, as depicted in step 203. In an alternative embodiment, as mentioned above, the attachment may be downloaded automatically, depending on the user's settings.

Subsequently, in step 204, the search module 130 generates a list of computing devices having the desired file on their hard drives as available for sharing over the distributed computing network. In step 205, the user clicks on a source, possibly a preferred source, for downloading the data from the list of available sources generated by search module 130, or, alternatively, the user may not be presented with any choice and the Data Access module may automatically determine the optimal set of sources to use for the download. To enable downloading a file from a peer computer, the peer-to-peer (“P2P”) protocol stack in user's computing device communicates with the P2P protocol stack of the computing device having the requested file. It establishes a connection, as shown in step 206, and downloads the file to the user's computing device. In a typical embodiment of a P2P file sharing, data downloaded by a user are immediately added to the shared file collection of the user, thereby making these data instantly available to other users on the network. In an alternative embodiment, the data can be saved in a special attachments folder, as is described in detail below.

In a preferred embodiment, the e-mail system not only allows a user sending an attachment to share out the file on the P2P network, but also provides the option for restricted access to the files being sent. For this purpose, the e-mail system provides three levels of privacy for attachments being sent—Public, Private and Secure.

Public attachments consist of data that originated in the P2P network, that is, files that were already public. Examples of such files may be shareware utilities, which are being shared amongst several users, and thus, a user would likely have no objection if people other than the designated recipients were also able to search for and download these files. Another class of public attachments can be data that a user willingly wants to share on the network. Examples of such data can be an audio file, a web page, a text document, a PDF file, a Powerpoint presentation, an Excel spreadsheet, a video, or any other document for which the user wants people to freely download.

A file is sent as a public attachment if the user checks the option 301 to make the file available to other users on the P2P network, as shown in FIG. 3. If the user makes the file available, if the file is not already present in the user's shared folder, the user is prompted to confirm, preferably via a dialog box 305, if they want to share out that file. The file is only available to be shared out to the public if it is located in a predesignated folder, such as a “shared” folder. This is to ensure that users are not inadvertently sharing out private or confidential files. After the user's confirmation, the file is copied to the user's shared folder and an identifier, preferably in the form of a file hash which is a unique 128-bit, 160-bit or other number or identifier that identifies the file, is sent to the recipient. The recipient can then download the file from the P2P network, or even locate the file on their own PC should it be present there, using the file hash or file identifier.

The file effectively becomes “public” because, being present in the predesignated folder, or shared folder, it is now subject to indexing and other cataloguing activity that ensures the file can be readily searched by persons who are neither the sender nor receiver of the original email. The file, therefore, becomes part of a conventional distributed computing network and its various indicia, including name, author, contents, format, file hash, or size, can be determined and made part of a central index that will direct searchers interested in any one of the various indicia to that file.

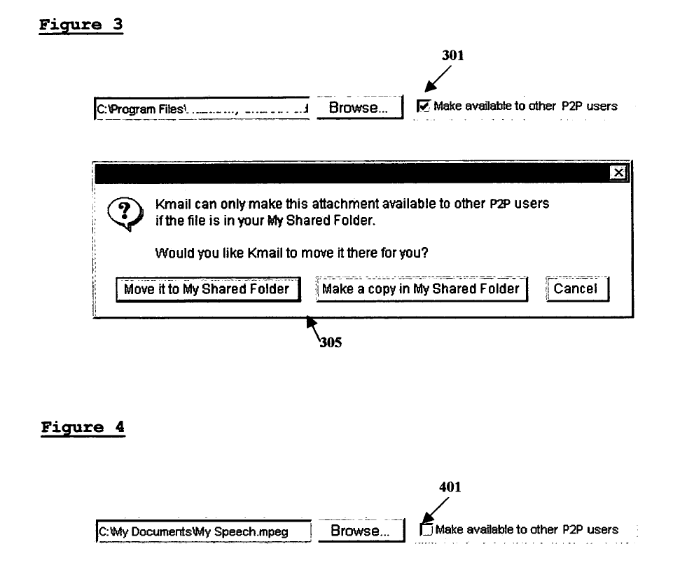

Private attachments are documents or files that are sent by the user, meant only for the recipient, so that no one else can view them. A file is sent as a private attachment if the user does not check the option 401 to make the file available to other users in the distributed computing network or the e-mail system, as shown in FIG. 4. In this case, the e-mail program only shares out the file from the user's computer by a specific identifier, such as its file hash, and not by any other metadata contained in the file. In order to retrieve a private attachment file from the P2P network, the person requesting the file (preferably, in this case, the recipient of the e-mail message containing the attachment) must know its file hash or file identifier. Since file hashes are unique large (e.g. 160-bit) numbers, the likelihood of anyone other than the intended recipient guessing the file hash of any file on the P2P network is highly improbable. Because the file is not subject to the general indexing function that extracts various indicia of the file and integrates those indicia to a publicly accessible central index, the only way to find the file is by knowing the specific identifier, i.e. the file hash, used to identify the file.

In a preferred embodiment, private files are shared from any location in the user's hard drive and need not be stored in the user's shared folder. In yet another preferred embodiment, if the user later moves the file to another location on their computer, the e-mail program will automatically find the file's new location. This is made possible by periodically scanning the hard drive for moved files.

Alternatively, if users do not wish to share out files or private attachments that are not stored in the shared folder from any location on their computer (their hard disk in particular), they can maintain a specific folder of shared attachment files and the e-mail program will not share out any files outside this folder on the network. It may be impractical to continuously scan the hard drive to resynchronize files that have moved and therefore advantageous to keep them all in one location. For example, a special “Attachments” folder may be created. The files inside this folder are only shared out by file hash and not their metadata. Users will therefore know exactly which data files are being shared out at any time and can be certain that only items in these folders are being shared. Optionally, a cache management or cleanup utility may be provided in the application software of present invention 100 allowing the present system to delete old files or those over a certain age.

While the option for private attachments provides some level of privacy, it is not completely secure. Like other e-mail traffic, e-mail messages in present invention 100 may be transmitted over the Internet as unencrypted data. A third party eavesdropping on Internet packets could read the e-mails being transmitted. Although the majority of e-mail protocols transmit messages without encryption, the e-mail program of the present invention allows users to use various encryption protocols. In one embodiment, the PGP protocol, well known to those of skill in the art, is used to encrypt e-mail messages before transmission. Thus, if an attachment has a .pgp or .asc file extension, indicating that it has been encrypted, then the e-mail program does not share out the file on the P2P network. Also, the e-mail program automatically launches the PGP protocol when the user opens a .pgp or .asc attachment. Preferably, the e-mail system of present invention offers a secure mail option to users, which makes use of a dedicated secure link for transmission of the e-mail body to or from the mail server and automatically encrypts attachments, using PGP or any other encryption algorithm.

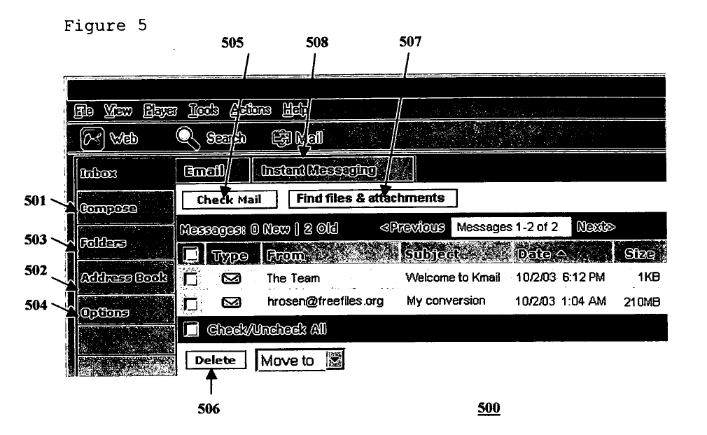

FIG. 5 illustrates an exemplary GUI 500 of the e-mail program of present invention 100, depicting the main menu and tool bars. GUI 500 can be an application residing locally on the computing device or web-based e-mail application. GUI 500 provides for clickable buttons allowing the user to perform many tasks, which include, but is not limited to composing a message 501, creating an address book 502, storing e-mail messages in various folders 503, choosing e-mail preference options 504, checking mail 505, and deleting messages 506. The e-mail program of present invention also provides functions for searching files on the P2P network, which can be invoked using the “Find files & attachments” button available on the GUI's main screen 507 and for instant messaging 508, using a button preferably provided below the GUI's menu bar.

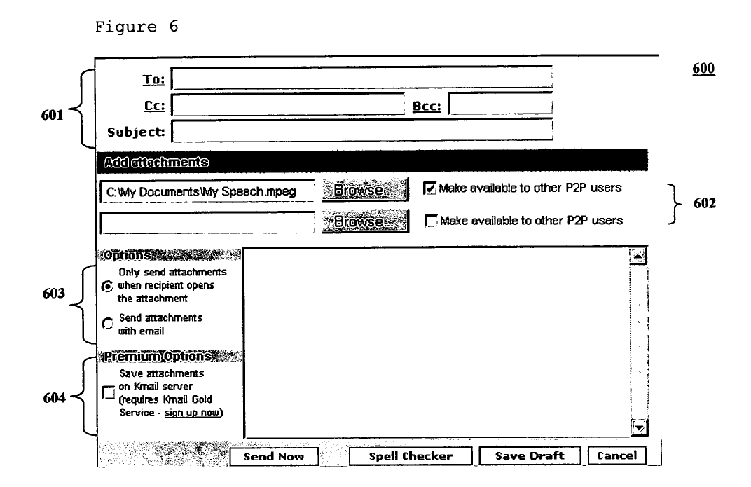

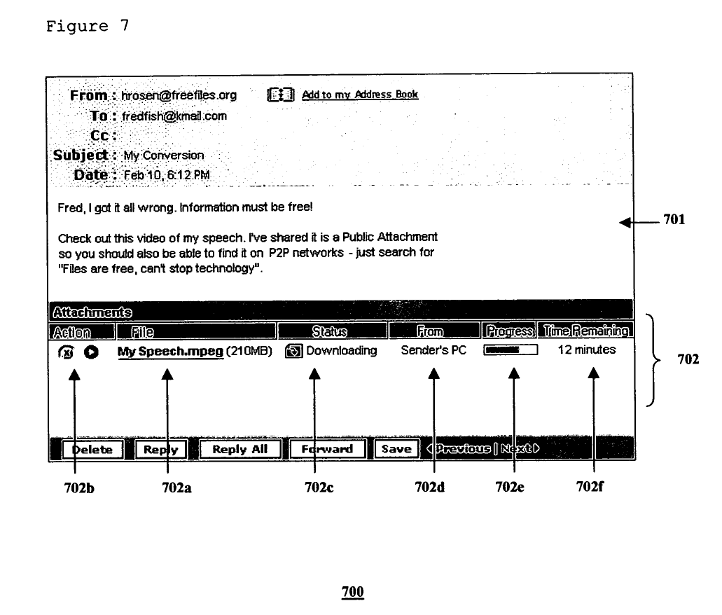

FIG. 6 illustrates an exemplary GUI screen for sending e-mail using the e-mail program of present invention. In addition to the options provided in conventional email applications, such as the intended recipients and subject of the email, 601, the exemplary GUI 600 provides the user with the option 602 to make available any attachments sent by them on the P2P network. This allows users other than the recipient to also locate the attachment files, as described in detail above with reference to FIGS. 3 and 4. The user also has the option 603 to send the attachment immediately, or, in the alternative, the user can send only the body of the e-mail, with the attachment sent when the recipient opens the e-mail and chooses to download the attachment. Optionally, the e-mail program will offer certain premium options 604, available to the user for some payment. One such option involves having the e-mail server act as storage for the user's e-mail attachments.

FIG. 7 depicts an exemplary GUI 700 for receiving an e-mail using the e-mail system of present invention. The text of the e-mail message is displayed in a first area 701 when the user indicates a desire to see the e-mail message, such as by clicking on the message in the user's Inbox, as shown in FIG. 6. The attachment download link(s) and/or identifier(s) are integrated into the e-mail message into a second area 702 and contained preferably below the text of the e-mail 701. The second area 702 preferably comprises a plurality of graphical indications, including the file to be accessed 702a, an associated action 702b, such as cancel downloading or activating the file, a status 702c, such as “downloading the file”, “searching for the file”, or “can't find the file”, an indication of where the file is being accessed 702d, a progress indicator 702e, and the time remaining for downloading or accessing the file 702f. The e-mail system allows for the searching and downloading of the attachments after the user clicks on an icon, or some other graphical representation, indicating that it wishes to download the attachment.

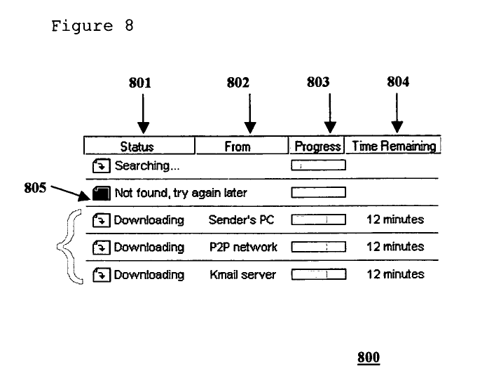

Once the user indicates a desire to open an attachment, i.e. by clicking on a link, icon, or other graphical representation, the user preferably is shown a graphical display indicating that the e-mail system is searching for it. Referring to FIG. 8, a graphical display 800 displays a plurality of statuses 801, a list of source computing devices from where each attachment may be accessed 802, progress in the accessing of each attachment 803, and remaining time for accessing the attachment(s) 804. If the attachment cannot be found at a particular time, then the e-mail system of present invention shows a red status icon 805, informing the user that the attachment cannot be found. The e-mail system can be preferably customized to automatically try again later and alert the user when download is complete or ask the user if the system should search for an alternative source or if the user can provide the location of an alternative source.

In another preferred embodiment, the e-mail system of present invention can accommodate the transmission and reception of email from users having applications and computing devices covered by the present invention and users who do not have applications and computing devices covered by the present invention (Non-Users). If a user of the present invention attempts to send an e-mail to a Non-User, with a potentially large attachment, the e-mail and attachment are sent as if it had been sent from a regular e-mail account. The e-mail system of the present invention will recognize that the Non-User has an e-mail address that is not part of the distributing computing email system disclosed herein, and instead of sending a link or identifier, such as a file hash link, the e-mail system of the present invention will add the entire attachment to the e-mail.

If a Non-User attempts to send an e-mail to a user of the present invention (User), and if the e-mail does not contain an attachment, then the User will simply receive the e-mail.

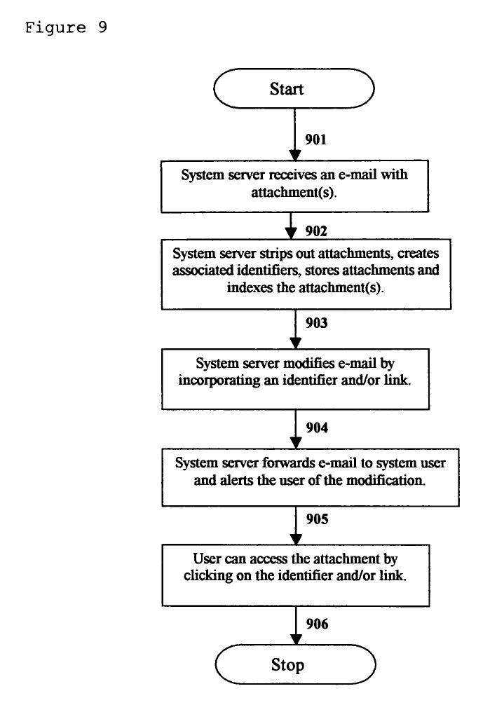

Referring to FIG. 9, if, however, the e-mail does contain an attachment, the server effectuating the present invention will 1) remove the attachment 902, 2) index the attachment by associating it with the link or identifier information 902, 3) store the attachment 902, 4) modify the e-mail by incorporating a link or identifier associated with the attachment 903, 5) send the modified e-mail to the User 904, 6) alert the User that an attachment was removed from the message 904, 7) enable the User to access the attachment by clicking on the link or identifier 905, and 8) optionally informing the Non-User that the e-mail was modified. The attachment is preferably stored on the server or, alternatively, on a plurality of computing devices in data communication with the network.

The above examples are merely illustrative of the many applications of the system of the present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A method for transmitting an e-mail attachment over a network, the method comprising:
generating an identifier for the attachment, the attachment being stored in a storage medium local to at least one computing device coupled to the network, wherein the at least one computing device includes a sender computing device;
transmitting the identifier along with a primary e-mail message from the sender computing device to a recipient computing device coupled to the network; and
retrieving the attachment by the recipient computing device, wherein retrieving the attachment further comprises:
searching for the attachment in at least one computing device coupled to the network using the identifier; and
downloading the attachment from the at least one computing device to a storage medium local to the recipient computing device.

2. The method of claim 1, wherein the network is a peer-to-peer-network.

3. The method of claim 1, wherein the computing device is any one of a personal computer, laptop, personal data assistant, mobile phone, wireless e-mail manager, media player, computing tablet, set-top box, and networked DVD player.

4. The method of claim 1, wherein the attachment is a file comprising data, wherein said data are at least one of text, video, images, audio, or video.

5. The method of claim 1, wherein the identifier comprises a file hash of the attachment.

6. The method of claim 1, wherein retrieving the attachment is performed upon request by user of the recipient computing device.

7. The method of claim 1, wherein retrieving the attachment is performed automatically for a predetermined set of sending users.

8. The method of claim 1, further comprising sharing the attachment, by the sender computing device, with a plurality of computing devices connected to the network subsequent to a search and request function.

9. The method of claim 1, further comprising the step of searching the recipient computing device using said identifier for said attachment prior to searching a plurality of other devices for said attachment.

10. A method for retrieving an e-mail attachment by a recipient computing device coupled to a network, the attachment having an identifier, the identifier being attached to a primary e-mail message received by the recipient computing device, the method comprising:
searching for the attachment in at least one computing device coupled to the network using the identifier; and
downloading the attachment from the at least one computing device to a storage medium local to the recipient computing device.

11. The method of claim 10, wherein the at least one computing device comprises a sender computing device.

12. The method of claim 10, wherein the network is a peer-to-peer network.

13. The method of claim 10, wherein the identifier comprises a file hash of the attachment.

14. The method of claim 10, wherein retrieving the attachment is performed upon request by a user of the recipient computing device.

15. The method of claim 10, wherein retrieving the attachment is performed automatically for a predetermined set of sending users.

16. A computer program product for transmitting a file attachment over a network, the computer program product comprising:
a computer readable program code for generating an identifier for the attachment, the attachment being stored in storage medium local to at least one computing device coupled to the network, wherein the at least one computing device includes a sender computing device;
a computer readable program code for transmitting the identifier along with a primary e-mail message from the sender computing device to a recipient computing device coupled the network; and
a computer readable program code for retrieving the attachment by the recipient computing device, the computer readable program code for retrieving the attachment further comprising:
a computer readable program code for searching the attachment in the at least one computing device coupled to the network using the identifier; and
a computer readable program code for downloading the attachment from the at least one computing device to a storage medium local to the recipient computing device.

17. The computer program product of claim 16, wherein the network is a peer-to-peer-network.

18. The computer program product of claim 16, wherein the computing device is any one of a personal computer, laptop, personal data assistant, mobile phone, wireless e-mail manager, media player, computing tablet, set-top box, and networked DVD player.

19. The computer program product of claim 16, wherein the attachment is a file comprising data, wherein said data are typically text, video, images, audio, video, and other information.

20. The computer program product of claim 16, wherein the unique identifier comprises a file hash of the attachment.

21. The computer program product of claim 16, comprising a computer readable program code for retrieving the attachment upon request by a user of the recipient computing device.

22. The computer program product of claim 16, comprising a computer readable program code for retrieving the attachment automatically for a predetermined set of sending users.

23. The computer program product of claim 16, further comprising computer readable program code for sharing the attachment by the sender computing device with a plurality of computing devices connected to the network subsequent to a search and request function.

24. A computer program product for retrieving an e-mail attachment by a recipient computing device coupled to a network, the attachment having an identifier, the identifier being attached to a primary e-mail message received by the recipient computing device, the computer program product comprising:
computer readable program code for searching the attachment in at least one computing device coupled to the network using the identifier; and
computer readable program code for downloading the attachment from the at least one computing device to a storage medium local to the recipient computing device.

25. The computer program product of claim 24, wherein the at least one computing device comprises a sender computing device.

26. The computer program product of claim 24, wherein the network is a peer-to-peer network.

27. The computer program product of claim 24, wherein the identifier comprises a file hash of the attachment.

28. The computer program product of claim 24, comprising computer readable program code for retrieving the attachment upon request by a user of the recipient computing device.

29. The computer program product of claim 24, comprising a computer readable program code for retrieving the attachment automatically for a predetermined set of sending users.
